(19) United States
(12) Patent Application Publication
(10) Pub. No.: US 2025/0042382 A1
(43) Pub. Date: Feb. 6, 2025

(54) BRAKE SYSTEM WITH REDUNDANT BRAKE UNIT

(71) Applicant: BWI (Shanghai) Co., Ltd., Shanghai (CN)

(72) Inventors: David Fredrick REUTER, Beavercreek, OH (US); Daniel Norbert BORGEMENKE, Springboro, OH (US); Michael James Dvorscak, Swartz Creek, MI (US)

(21) Appl. No.: 18/791,411

(22) Filed: Jul. 31, 2024

Related U.S. Application Data
(60) Provisional application No. 63/530,382, filed on Aug. 2, 2023.

(30) Foreign Application Priority Data
Jul. 17, 2024 (CN) 202410963926.4

(51) Int. Cl. B60T 13/68; B60T 8/171; B60T 8/172; B60T 8/94; B60T 13/14; B60T 13/58; B60T 13/62

(52) U.S. Cl. CPC B60T 13/686; B60T 8/171; B60T 8/172; B60T 8/94; B60T 13/142; B60T 13/148; B60T 13/588; B60T 13/62; B60T 2240/00; B60T 2270/402; B60T 2270/413

(57) ABSTRACT

A redundant brake unit for a motor vehicle comprises: an inlet port configured to receive fluid under pressure from an external source; an outlet port connected to a supply passage and configured for fluid connection to a wheel brake; a reservoir port connected to a return passage and configured for fluid connection to a fluid reservoir; a boost valve configured to selectively control fluid communication between the inlet port and the supply passage; and a pressure supply unit including a pump element configured to pump fluid between the return passage and the supply passage. The pump element has an inlet directly connected to the reservoir port with no actuated valves therebetween. A normally-closed valve and a throttle valve are disposed in a series configuration between the supply passage and the return passage, with the throttle valve being operable to control a fluid pressure in the supply passage.

### CROSS REFERENCE TO RELATED APPLICATIONS

This U.S. utility patent application claims the benefit of U.S. Provisional Patent Application No. 63/530,382, filed Aug. 2, 2023, and claims priority to Chinese Patent Application No. 202410963926.4 filed Jul. 17, 2024, which are incorporated herein by reference in their entirety.

### BACKGROUND OF THE INVENTION

### 1. Field of the Invention

The present disclosure relates generally to brake systems for vehicles, such as automobiles. More specifically, the present disclosure relates to a brake-by-wire system with two integrated braking units to provide redundancy.

### 2. Related Art

As electric and hybrid vehicles continue to proliferate in markets around the world, it is well understood that significant lengthening of battery life can be obtained by utilizing the motor-generator output capabilities of that device during braking. However, the input torque in the generator mode used to recharge batteries is not consistent with driver input function of pedal force/travel verses vehicle deceleration. In order to achieve that complex function, the hydraulic brakes of the vehicle must supply the difference between generator braking torque and driver requested braking torque.

The engineering world has understood this requirement for a number of years commonly known as regenerative brake blending. A most efficient way to achieve this is to use a “brake-by-wire” technique. To accomplish this, the brake pedal in effect becomes a joystick, so it must be connected to a travel and/or force sensor in order to send a signal to the system ECU that will interpret this as driver's intent of a desired vehicle deceleration. In addition, the brake pedal “feel” must be simulated by the appropriate force-travel relationship and must also have the ability to be isolated from directly applying the master cylinder to the wheel brakes. Brake-by-wire systems typically include a pressure supply unit (PSU) to provide a supply of pressurized fluid for actuating the wheel brakes.

As brake-by-wire systems are applied to vehicles desiring Level 3, 4 or 5 of the defined SAE autonomy scale, a redundant backup system may be required to allow the vehicle to operate in the event of the primary brake unit failing. In designing for systems for SAE Autonomy Level 3 or higher, one of the key factors involved is that of redundancy. As the influence of the driver diminishes, the ability of the brake system to have a fallback mode that allows full or nearly full performance is required.

### SUMMARY OF THE INVENTION

The present disclosure provides a redundant brake unit for a motor vehicle. The redundant brake unit includes: an inlet port configured to receive fluid under pressure from an external source; an outlet port connected to a supply passage and configured for fluid connection to a wheel brake; a reservoir port connected to a return passage and configured for fluid connection to a fluid reservoir; a boost valve configured to selectively control fluid communication between the inlet port and the supply passage; and a pressure supply unit including a pump element configured to pump fluid between the return passage and the supply passage. The pump element has an inlet directly connected to the reservoir port with no actuated valves therebetween.

The present disclosure also provides a redundant brake unit for a motor vehicle. The redundant brake unit includes: an inlet port configured to receive fluid under pressure from an external source; an outlet port connected to a supply passage and configured for fluid connection to a wheel brake; a reservoir port connected to a return passage and configured for fluid connection to a fluid reservoir; a pressure supply unit including a pump element configured to pump fluid to the supply passage; and a normally-closed valve and a throttle valve in a series configuration between the supply passage and the return passage. The throttle valve is operable to vary fluid flow therethrough to control a fluid pressure in the supply passage.

The present disclosure also provides a brake system for a motor vehicle. The brake system includes: a wheel brake configured to apply a braking force in response to a fluid pressure; a primary brake unit including a first pressure supply unit (PSU) configured to generate the fluid pressure, and a fluid discharge port for providing the fluid pressure; and a redundant brake unit. The redundant brake unit includes: an inlet port fluidly coupled to the fluid discharge port of the primary brake unit, an outlet port connected to a supply passage and to the wheel brake, a boost valve configured to selectively control fluid communication between the inlet port and the supply passage, a reservoir port connected to a return passage and configured for fluid connection to a fluid reservoir, and a second PSU including a pump element configured to pump fluid between the return passage and the supply passage. The pump element has an inlet directly connected to the reservoir port with no actuated valves therebetween.

### BRIEF DESCRIPTION OF THE DRAWINGS

Further details, features and advantages of designs of the invention result from the following description of embodiment examples in reference to the associated drawings.

FIG. 1 shows a schematic block diagram of a brake-by-wire (BbW) system in a vehicle;

FIG. 2 shows a schematic block diagram of a two-box BbW system of the present disclosure;

FIG. 3 shows a schematic diagram of the two-box BbW system of FIG. 2;

FIG. 4 shows a schematic diagram of the two-box BbW system of FIG. 2, operating in a normal mode;

FIG. 5 shows a schematic diagram of the two-box BbW system of FIG. 2, operating in a fallback mode with modulated brakes;

FIG. 6 shows a schematic diagram of the two-box BbW system of FIG. 2, operating in a foot-off self-apply mode with no brake pedal application;

FIG. 7A shows a detailed schematic diagram of a redundant brake unit of the two-box BbW system of FIG. 2; and

FIG. 7B shows a detailed schematic diagram of a primary brake unit of the two-box BbW system of FIG. 2.

### DESCRIPTION OF THE ENABLING EMBODIMENTS

Referring to the drawings, the present invention will be described in detail in view of the following embodiments.

The present disclosure provides a two-box BbW system 20, which may include a redundant brake system (RBU), and which is capable of self-applying the brakes in case the driver is not alert (Level 3) or there is no driver (Levels 4 and 5). The two-box BbW system 20 of the present disclosure is unique, cost effective, and able to be constructed with existing brake controller components. The system of the present disclosure may be suitable for Level 3 or greater automation based on the “Levels of Driving Automation” standard by SAE International that defines six levels of driving automation, as specified in SAE standard J3016.

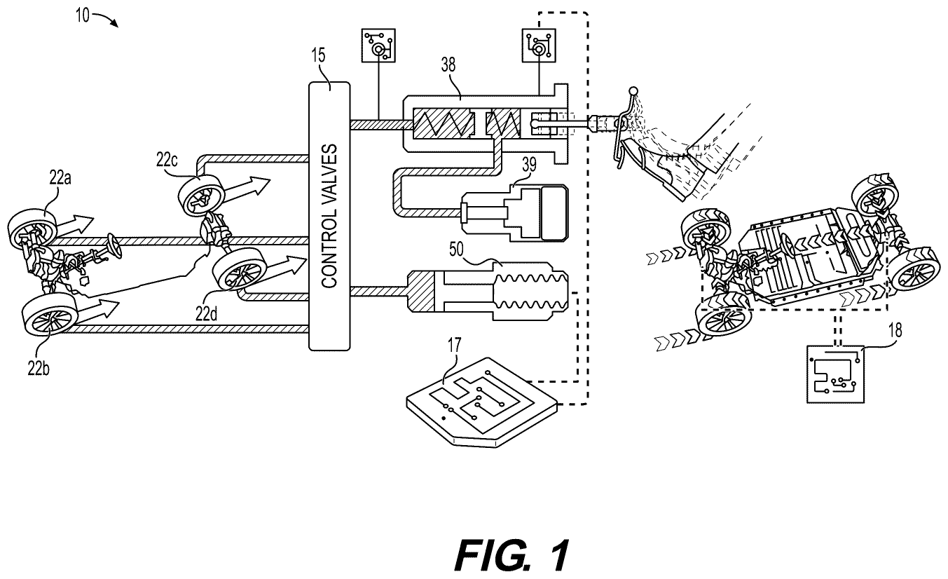

FIG. 1 shows a schematic block diagram of a brake-by-wire (BbW) system 10 in a vehicle, such as an automobile. Basic brake-by-wire (BBW) architecture is now well-established in the automotive industry. The master cylinder 38 either applies the brakes directly in a failed system fallback mode or is isolated from the wheel brakes 22a, 22b, 22c, 22d and connected to a pedal feel emulator (PFE) 39 that replicates force, travel, and damping of a traditional brake system. The brake pedal travel and/or force, and or brake pressure is used by the BbW system 10 as an input signal to a brake electronic control unit (ECU) 17. It in turn sends the appropriate signal to a first pressure supply unit (PSU) 50. The first PSU 50 may include a high efficiency brushless motor and ballscrew assembly displacing one or two pistons, which can be thought of as an electric master cylinder. The master cylinder 38 and/or the first PSU 50 may be coupled to the wheel brakes 22a, 22b, 22c, 22d via a series of control valves 15, which may include an apply valve and a release valve (not shown) for each of the wheel brakes 22a, 22b, 22c, 22d to provide functions such as antilock braking (ABS), electronic traction control, etc.

The brake pedal inputs define driver intent which determines how fast and how hard the brakes are applied with the goal to replicate the feel of a conventional vacuum booster brake system. The brake ECU 17 may also send a signal to a drive control unit (DCU) 18, which may also be called a powertrain control module (PCM), to slow the vehicle using one or more electric motors in a regenerative mode.

The vehicle's master cylinder either applies the brakes directly by the driver in a failed system fallback mode, or in normal mode, is totally isolated from the wheel brakes and connected to a pedal feel emulator that replicates force, travel, and damping of a traditional brake system. The brake pedal travel and/or force along with the measured hydraulic brake pressure is used by the system as an input signal to the electronic control unit. It in turn sends the appropriate signal to a pressure supply unit nowadays consisting of a high efficiency brushless motor and ballscrew assembly displacing one or two pistons. The applied pressure thus determines how fast and how hard the brakes are to be applied with the goal to replicate the driver's intended vehicle's instantaneous deceleration.

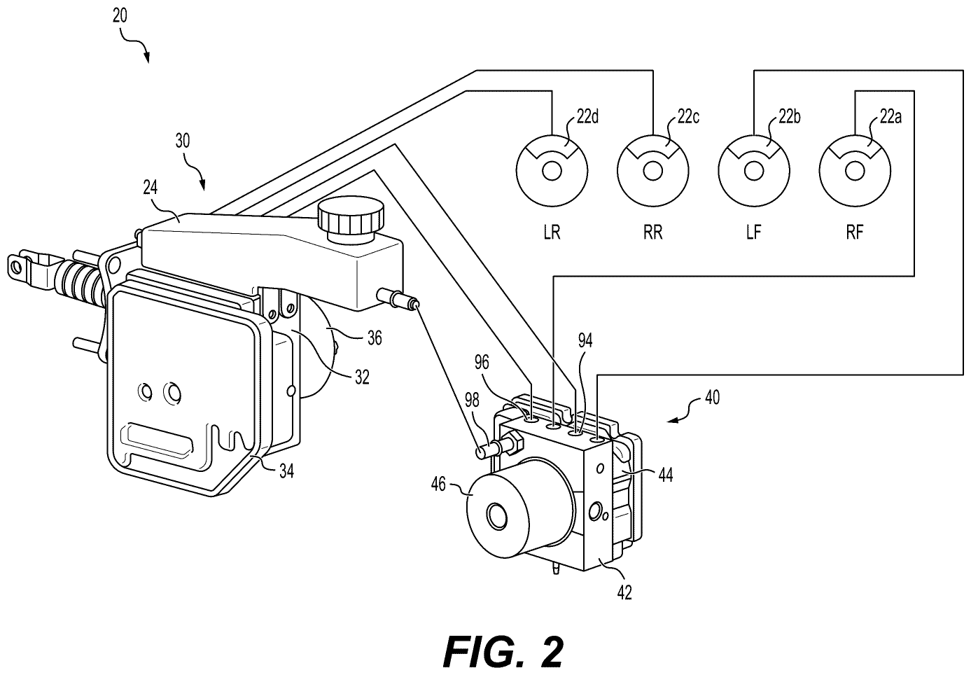

FIG. 2 shows a schematic diagram of a two-box BbW system 20 for controlling operation of the wheel brakes 22a, 22b, 22c, 22d of the vehicle. The wheel brakes 22a, 22b, 22c, 22d may also be called foundation brakes to distinguish from other braking systems, such as electric regenerative braking. The two-box BbW system 20 includes a primary brake unit 30 and a redundant brake unit (RBU) 40. The primary brake unit 30 includes a first hydraulic control unit (HCU) block 32 with a first electronic control unit (ECU) 34 and a first electric motor 52 each attached thereto. The first HCU block 32 is directly fluidly connected to a right-rear (RR) wheel brake 22c and a left-rear (LR) wheel brake 22d of the wheel brakes 22a, 22b, 22c, 22d. The RBU 40 includes a second hydraulic control unit (HCU) block 42 with a second electronic control unit (ECU) 44 and a second electric motor 46 each attached thereto. The second HCU block 42 is directly fluidly connected to a right-front (RF) wheel brake 22a and a left-front (LF) wheel brake 22b of the wheel brakes 22a, 22b, 22c, 22d. The first HCU block 32 is directly fluidly connected to a right-front (RF) inlet port 96 and a left-front (LF) inlet port 94 of the HCU block 42. The first HCU reservoir 24, is fluidly connected to a second HCU reservoir inlet port 98. In some modes, the second HCU block 42 may function as a pass-through for the primary brake unit 30 to actuate the RF wheel brake 22a and the LF wheel brake 22b.

In some embodiments, an electronic HCU (EHUC) that is otherwise capable of controlling an entire brake system, such as a DBC 1280 EHCU from BWI, can be modified to meet such requirements. The DBC 1280 EHCU contains a power source (i.e. dual pump elements), hydraulic controls (i.e. solenoid valves), as well as electronic controls (ECU).

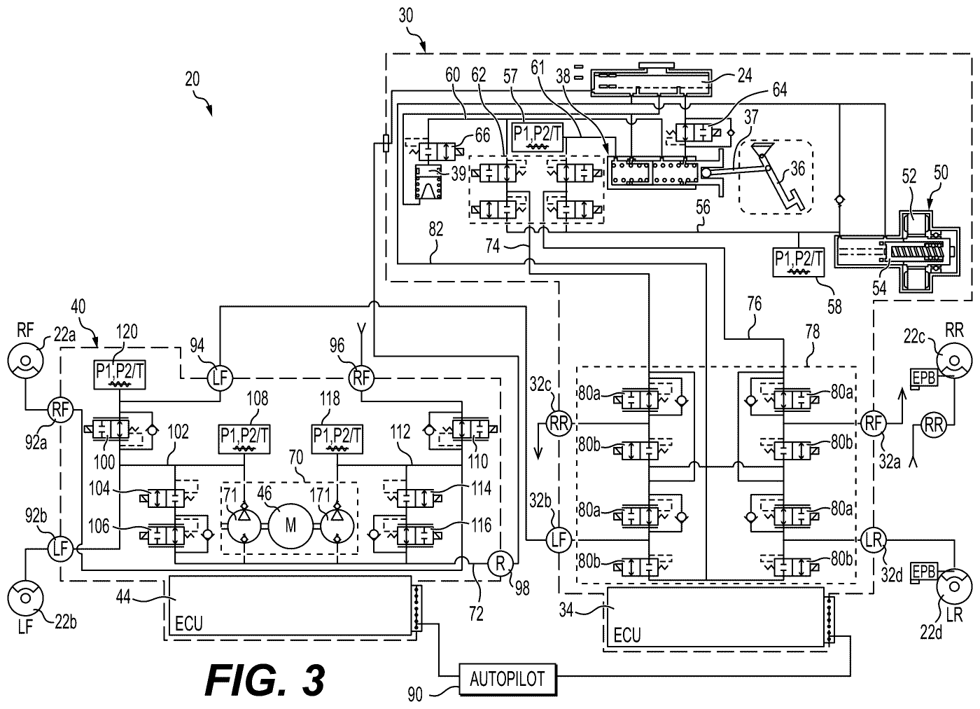

FIG. 3 shows a schematic diagram of the two-box BbW system 20. As shown, the two-box BbW system 20 includes the RBU 40 fluidly coupled with a standard one-box brake-by-wire system of the primary brake unit 30.

FIG. 3 shows structural details of the primary brake unit 30, which includes a set of valves 62 configured to selectively control fluid flow from the master cylinder 38 and the first PSU 50 and to each of a first brake circuit 74 and a second brake circuit 76. In some embodiments, and as shown in FIG. 3, the set of valves 62 includes a conventional H-bridge hydraulic circuit for controlling operation of the wheel brakes 22a, 22b, 22c, 22d of the vehicle. This concept of a safety fallback circuit using paired normally open and normally closed valves was first demonstrated in U.S. Pat. No. 6,533,369 B2. However, the concepts of the present disclosure may be applied using other types of primary brake units 30, such as a brake controller having a different configuration of the set of valves 62, with or without the H-bridge hydraulic configuration. One or more of the wheels of vehicles using BbW systems may be powered by an internal combustion engine. Additionally or alternatively, one or more of the wheels of vehicles using BbW systems may be powered by an electric motor, such as with pure electric vehicles. Additionally or alternatively, and as is the case with some hybrid vehicles, one or more of the wheels of vehicles using BbW systems may be powered by both an electric motor and an internal combustion engines in a sharing configuration. Most vehicle using BbW systems fall into the latter two categories.

The primary brake unit 30 includes a fluid reservoir 24 holding a hydraulic fluid and supplying the hydraulic fluid to a master cylinder 38. In some embodiments, and as shown in FIG. 3, the master cylinder 38 is a dual-circuit unit. However, the master cylinder 38 may have a different configuration. A reservoir test valve 64 selectively controls fluid flow from the fluid reservoir 24 to the master cylinder 38. The master cylinder 38 is configured to supply fluid pressure in each of a first master cylinder (MC) fluid passageway 60 and a second MC fluid passageway 61 in response to application of a brake pedal 36. The brake pedal 36 is coupled to press a brake linkage 37 which, in turn, presses a primary piston of the master cylinder 38. The MC fluid passageways 60, 61 may be fluidly isolated from one another to provide redundancy in case of a failure, such as a leak, in one of the two MC fluid passageways 60, 61. A first pressure sensor 57 monitors the pressure in the second MC fluid passageway 61.

Still referring to FIG. 3, a PFE 39 is selectively fluidly coupled to the first MC fluid passageway 60 via a PFE isolation valve 66 to selectively provide a natural feeling of brake operation, particularly when the master cylinder 38 is decoupled from operating the wheel brakes. The PFE 39 also includes a lower chamber that is fluidly coupled to the fluid reservoir 24 via a return fluid passageway.

The first pressure supply unit (PSU) 50 includes the first electric motor 52 and a PSU pump 54 to supply the hydraulic fluid from the fluid reservoir 24 to a PSU fluid passageway 56. A second check valve allows fluid flow from the fluid reservoir 24 into the PSU fluid passageway 56 while blocking fluid flow in an opposite direction. A second pressure sensor 58 monitors the pressure in the PSU fluid passageway 56.

This hydraulic layout includes a set of valves 62 with an H-bridge circuit arrangement having four valves that control the switching between the MC fluid passageways 60, 61 of the master cylinder 38 and the first PSU 50 and to control fluid flow to the wheel brakes 22a, 22b, 22c, 22d via each of the first brake circuit 74 and the second brake circuit 76.

The primary brake unit 30 defines four fluid discharge ports 32a, 32b, 32c, 32d each fluidly coupled to a corresponding one of the wheel brakes 22a, 22b, 22c, 22d. A control valve manifold 78 fluidly connects the two brake circuits 74, 76 to the corresponding wheel brakes 22a, 22b, 22c, 22d via the four fluid discharge ports 32a, 32b, 32c, 32d. The control valve manifold 78 includes an apply valve 68a and a release valve 80b corresponding to each of the wheel brakes 22a, 22b, 22c, 22d to selectively control fluid flow between the corresponding one of the of the wheel brakes 22a, 22b, 22c, 22d and an associated one of the two brake circuits 74, 76. The apply valves 80a and the release valves 80b may collectively be called antilock brake system (ABS) valves for their use in such an ABS. However, the apply valves 80a and the release valves 80b may be used for other functions, such as for traction control and/or for torque vectoring. A return fluid passageway 82 provides fluid communication for flow from the control valve manifold 78 and back to the fluid reservoir 24.

Besides the eight standard ABS valves 80a, 80b, and the four H-bridge hydraulic control valves 62, conventional brake-by-wire systems include two more valves 64, 66, bringing the total to fourteen (14) valves. The PFE isolation valve 66 is a normally-closed valve and its sole purpose is to lock out the PFE 39 in the event of a failed pressure supply unit when master cylinder backup is required. The reservoir test valve 64 may be used to shut off the primary master cylinder return path to the fluid reservoir 24 so that the system may conduct a self-test to make sure the PFE isolation valve 66 and other valves are functioning properly.

The first ECU 34 may include one or more processors, microcontrollers, and/or electric circuits configured to control operation of one or more of the valves 62, 80a, 80b, 64, 66, to monitor one or more of the first pressure sensor 57 and the second pressure sensor 58 and/or to control operation of the first electric motor 52, and to thereby coordinate operation of the primary brake unit 30.

In some embodiments, a first set 32a, 32b of the four fluid discharge ports 32a, 32b, 32c, 32d is fluidly coupled to corresponding first wheel brakes 22a, 22b via the RBU 40, and a second set 32c, 32d of the four fluid discharge ports 32a, 32b, 32c, 32d are directly fluidly coupled to corresponding second wheel brakes 22c, 22d. For example, and as shown in FIG. 3, the RR wheel brake 22c and the LR wheel brake 22d may each be directly fluidly connected to corresponding ports of the second set 32c, 32d of the four fluid discharge ports 32a, 32b, 32c, 32d and to receive fluid from corresponding ones of the two brake circuits 74, 76. Additionally, and as also shown in FIG. 3, the RF wheel brake 22a and the LF wheel brake 22b may each be fluidly connected to corresponding ports of the first set 32a, 32b of the four fluid discharge ports 32a, 32b, 32c, 32d via the RBU 40, and to receive fluid from corresponding ones of the two brake circuits 74, 76.

The RBU 40 provides fallback brake operation. The RBU 40 may operate independently on front wheels only. In a normal brake-by-wire mode, fluid may pass through the RBU 40 for the primary brake unit 30 to actuate the RF wheel brake 22a and the LF wheel brake 22b. In the fallback mode, the second PSU 70 of the RBU 40 may run continuously when brakes applied. Both of the two brake circuits 74, 76 in the primary brake unit 30 are input to the RBU 40.

The RBU 40 includes a first inlet port 94 and a second fluid input port 96, Each of the inlet ports 94, 96 are configured to receive fluid under pressure from an external source, such as the primary brake unit 30. As shown in FIG. 3, first inlet port 94 is directly fluidly connected to a LF fluid discharge port 32b of the four fluid discharge ports 32a, 32b, 32c, 32d of the primary brake unit 30. The second inlet port 96 is directly fluidly connected to a RF fluid discharge port 32a of the four fluid discharge ports 32a, 32b, 32c, 32d of the primary brake unit 30.

The RBU 40 also includes a RF outlet port 92a and a LF outlet port 92b. The RF outlet port 92a is directly fluidly connected to the RF wheel brake 22a for supplying fluid thereto, and the LF outlet port 92b is directly fluidly connected to the LF wheel brake 22b for supplying fluid thereto. The RBU 40 also includes a reservoir port 98 that is configured for fluid connection to the fluid reservoir 24. For example, and as shown in FIG. 3, a line connects the reservoir port 98 through the primary brake unit 30 and to the fluid reservoir 24, providing fluid communication therebetween.

The RBU 40 includes a second PSU 70 that includes the second electric motor 46 coupled to two pump elements 71, 171, with each of the two pump elements 71, 171 configured to pump fluid from a return passage 72 that is fluidly connected to the to the fluid reservoir 24 via the reservoir port 98. Each of the two pump elements 71, 171 includes an inlet for receiving the fluid and which is directly fluidly connected to the reservoir port 98, with no actuated valves therebetween. In some embodiments, and as shown in FIG. 3, there are no valves of any kind in a fluid path between the reservoir port 98 and the inlets of the two pump elements 71, 171. The two pump elements 71, 171 include a first pump element 71 that is configured to pump fluid from the return passage 72 and into a first supply passage 102. The two pump elements 71, 171 also include a second pump element 171 that is configured to pump fluid from the return passage 72 and into a second supply passage 112. The first supply passage 102 is fluidly connected to the LF outlet port 92b for supplying fluid to the LF wheel brake 22b, and the second supply passage 112 is fluidly connected to the RF outlet port 92a for supplying fluid to the RF wheel brake 22a. A third pressure sensor 108 monitors the pressure in the first supply passage 102, and a fourth pressure sensor 118 monitors the pressure in the second supply passage 112. The third pressure sensor 108 and the fourth pressure sensor 118 may also be called outlet fluid pressure sensors. The third pressure sensor 108 is electrically connected to the second ECU 44 and provides a first outlet pressure signal P-OUT-L thereto representing the fluid pressure in the first supply passage 102. The fourth pressure sensor 118 is electrically connected to the second ECU 44 and provides a second outlet pressure signal P-OUT-R thereto representing the fluid pressure in the second supply passage 112.

A fifth fluid pressure sensor 120, which may also be called an inlet fluid pressure sensor, monitors pressure in a fluid passage of the RBU 40 that is connected to the first inlet port 94. The fifth fluid pressure sensor 120 is electrically connected to the second ECU 44 and provides an inlet pressure signal P-IN thereto representing the fluid pressure at the first inlet port 94. Another inlet fluid pressure sensor (Not shown in the FIGS.) may be included to measure a fluid pressure at the second inlet fluid port 96.

The RBU 40 also includes a first boost valve 100, which may include a normally-open solenoid valve, fluidly connected between the first inlet port 94 and the first supply passage 102 and configured to selectively control fluid communication therebetween. The first boost valve 100 may be energized, and thereby commanded to a closed position, in the fallback mode to prevent flow back to the primary brake unit 30. The RBU 40 also includes a first decrease valve 104 and a first throttle valve 106 connected in series therewith and together fluidly connected between the first supply passage 102 and the return passage 72. The first decrease valve 104 may include a normally-closed solenoid valve, and the first throttle valve 106 may include a normally-open modulating solenoid valve. The first decrease valve 104 may be de-energized, and thereby commanded to a closed position, in a normal braking mode to prevent a transfer of fluid from the first supply passage 102 to the reservoir 24. The first decrease valve 104 may be energized, and thereby commanded to an open position, in the fallback mode to permit flow from the first supply passage 102 to the first throttle valve 106. The first throttle valve 106 may be operated to regulate fluid pressure in the first supply passage 102, from an output of the first pump element 71, and for supply to the LF wheel brake 22b. The outlet pressure provided by the regulated pump flow, as measured by the third pressure sensor 108, is divided by an inlet pressure supplied by the driver, as measured by the fifth pressure sensor 120, to determine a boost ratio.

The RBU 40 also includes a second boost valve 110, which may include a normally-open solenoid valve, fluidly connected between the second inlet port 96 and the second supply passage 112 and configured to selectively control fluid communication therebetween. The second boost valve 110 may be energized, and thereby commanded to a closed position, in the fallback mode to prevent flow back to the primary brake unit 30. The RBU 40 also includes a second decrease valve 114 and a second throttle valve 116 connected in series therewith and together fluidly connected between the second supply passage 112 and the return passage 72. The second decrease valve 114 may include a normally-closed solenoid valve, and the second throttle valve 116 may include a normally-open modulating solenoid valve. The second decrease valve 104 may be de-energized, and thereby commanded to a closed position, in the normal braking mode to prevent a transfer of fluid from second supply passage 112 to reservoir 24. The second decrease valve 104 may be energized, and thereby commanded to an open position, in the fallback mode to permit flow from the first supply passage 112 to the first throttle valve 116. The second throttle valve 116 may be operated to regulate fluid pressure in the second supply passage 112, from an output of the second pump element 171, and for supply to the RF wheel brake 22a.

The second ECU 44 may include one or more processors, microcontrollers, and/or electric circuits configured to control operation of one or more of the valves 100, 104, 106, 110, 114, 116, to monitor one or more of the pressure sensors 108, 118, 120, and/or to control operation of the second electric motor 46, and to thereby coordinate operation of the RBU 40. For example, the second ECU 44 may receive a signal from the third pressure sensor 108 representing the pressure in the first supply passage 102 and provide control signals to either or both of the first boost valve 100 and/or the first throttle valve 106 for adjusting the pressure in the first supply passage 102. Additionally or alternatively, the second ECU 44 may receive a signal from the fourth pressure sensor 118 representing the pressure in the second supply passage 112 and provide control signals to either or both of the second boost valve 110 and/or the second throttle valve 116 for adjusting the pressure in the second supply passage 112.

One or more ECUs, such as the second ECU 44, may be configured to determine a pressure differential across the first boost valve 100 based on a difference between the fluid pressure in the first supply passage 102 and the fluid pressure at the first inlet port 94. The one or more ECUs may be further configured to determine a desired output pressure setting based on the difference between the fluid pressure in the first supply passage 102 and the fluid pressure at the first inlet port 94. The one or more ECUs may be further configured to generate a control signal for the first throttle valve 106 based on a difference between the desired output pressure setting and the fluid pressure in the first supply passage 102. The one or more ECUs may provide similar control functions for the second throttle valve 116. For example, the one or more ECUs may be configured to determine a pressure differential across the second boost valve 110 and to determine a second desired output pressure setting based on a difference between the fluid pressure in the second supply passage 112 and the fluid pressure at the first inlet port 94. The one or more ECU. As may be further configured to generate a control second signal for the second throttle valve 116 based on a difference between the second desired output pressure setting and the fluid pressure in the second supply passage 112.

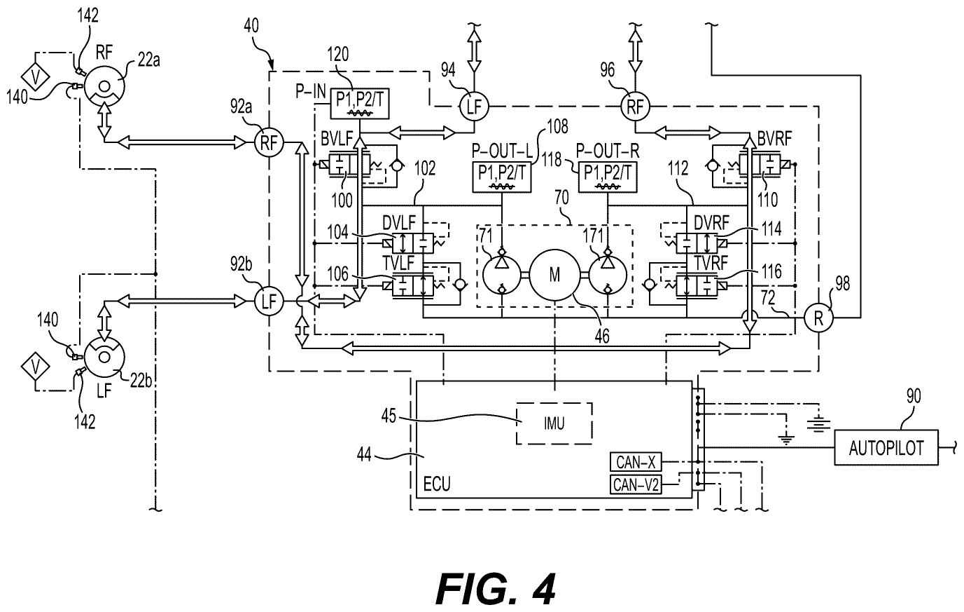

FIG. 4 shows a schematic diagram of a portion of the two-box BbW system, operating in a normal mode, which may also be called a pass-through mode. As shown, an autopilot controller 90 is functionally connected to the second ECU 44 for commanding braking operation in autonomous operation. In some embodiments, and as shown in FIG. 4, the second ECU 44 includes a first inertial sensor, also called an inertial measurement unit (IMU) 45 configured to sense longitudinal and lateral accelerations and/or yaw rate. FIG. 4 includes the following components BV=Boost Valve (defines boost ratio); DV=Decrease Valve (pressure decrease); and TV=Throttle Valve (regulates output pressure). A Pressure Supply Unit, such as the first PSU 50 from FIG. 3, provides hydraulic output to all of the wheel brakes 22a, 22b, 22c, 22d, including inputs to the RBU 40. The RBU 40 transfers PSU pressure from the primary brake unit 30 to actuate the RF wheel brake 22a and the LF wheel brake 22b. A driver experiences normal brake pedal effort, travel, and deceleration.

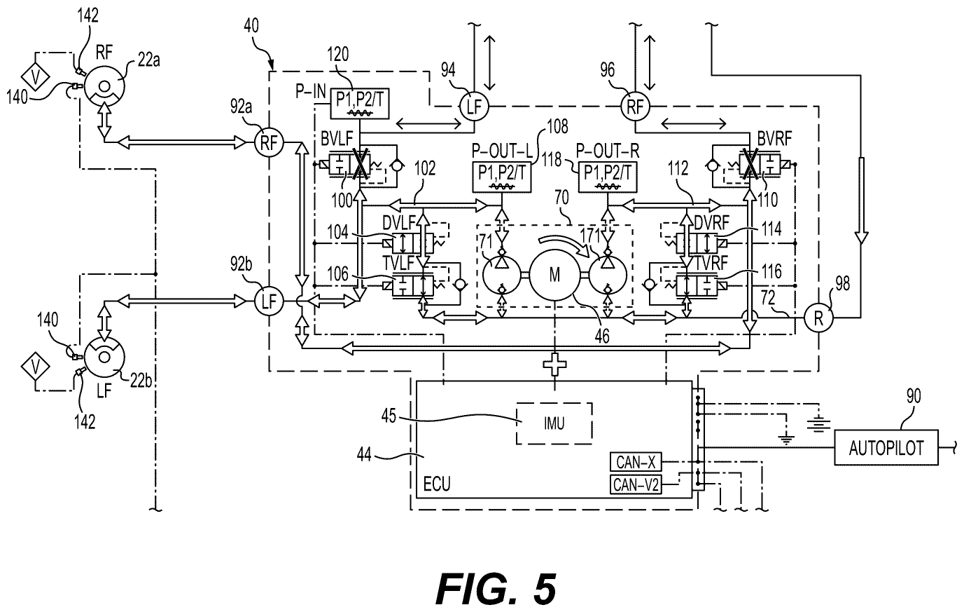

FIG. 5 shows a schematic diagram of a portion of the two-box BbW system 20, operating in a fallback mode with modulated brakes. As shown, low-pressure fluid from driver pushing on the master cylinder 38 is input into the RBU 40. The second PSU 70 of the RBU 40 runs continuously drawing in fluid as needed from the reservoir 24 by way of the reservoir port 98. Boost Valve delta pressure is Wheel Brake to Master Cylinder that defines the Boost Ratio. The boost valves 100, 110 each close when brakes are applied to prevent flowback to the master cylinder 38. Non-boosted rear wheel brakes 22c, 22d may provide pedal compliance. Throttle Valve delta pressure is Wheel Brake to the fluid reservoir 24. The throttle valves 106, 116 are each regulated to maintain constant pump recirculation and output pressure to the corresponding wheel brake 22a, 22b. The pressure sensors 120, 108, 118 may be used to control valve functions in the RBU 40 in the fallback mode.

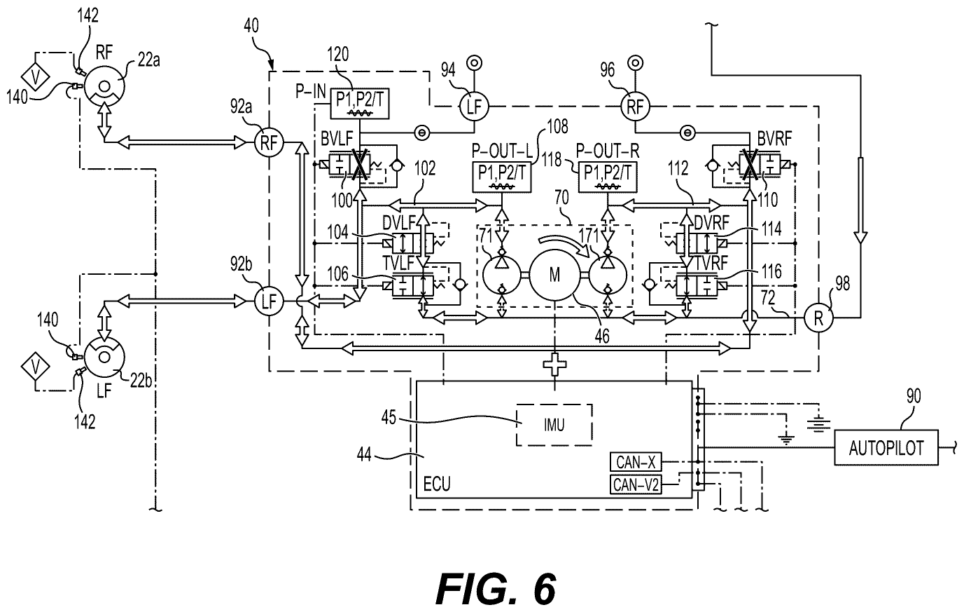

FIG. 6 shows a schematic diagram of a portion of the two-box BbW system 20, operating in a foot-off self-apply mode with no brake pedal application, in which the autopilot 90 is controlling vehicle deceleration. In this mode, the master cylinder 38 is at atmospheric pressure and connected to the fluid reservoir 24. In this mode, inlet ports 94, 96 are each at a low-pressure, atmospheric state, as indicated by open O's over the fluid lines attached thereto. The second PSU 70 of the RBU 40 runs continuously drawing in fluid as needed from the reservoir 24 by way of the reservoir port 98. The boost valves 100, 110 each close when brakes are applied to prevent flowback to the master cylinder 38. Throttle Valve delta pressure is Wheel Brake to the fluid reservoir 24. The throttle valves 106, 116 are each regulated to maintain constant pump recirculation and output pressure to the corresponding wheel brake 22a, 22b. The pressure sensors 120, 108, 118 may be used to control valve functions in the RBU 40 in the foot-off self-apply mode.

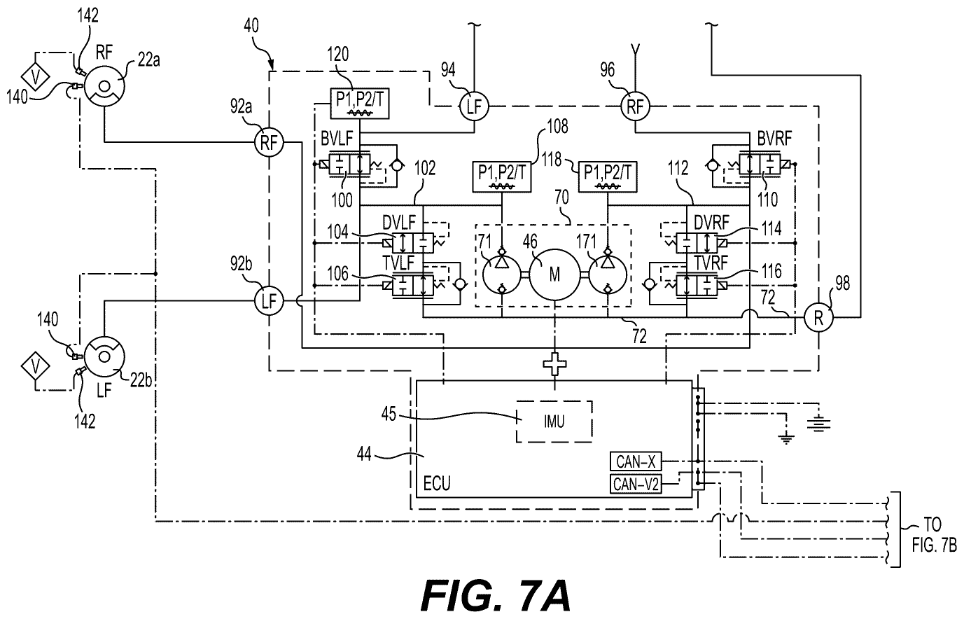

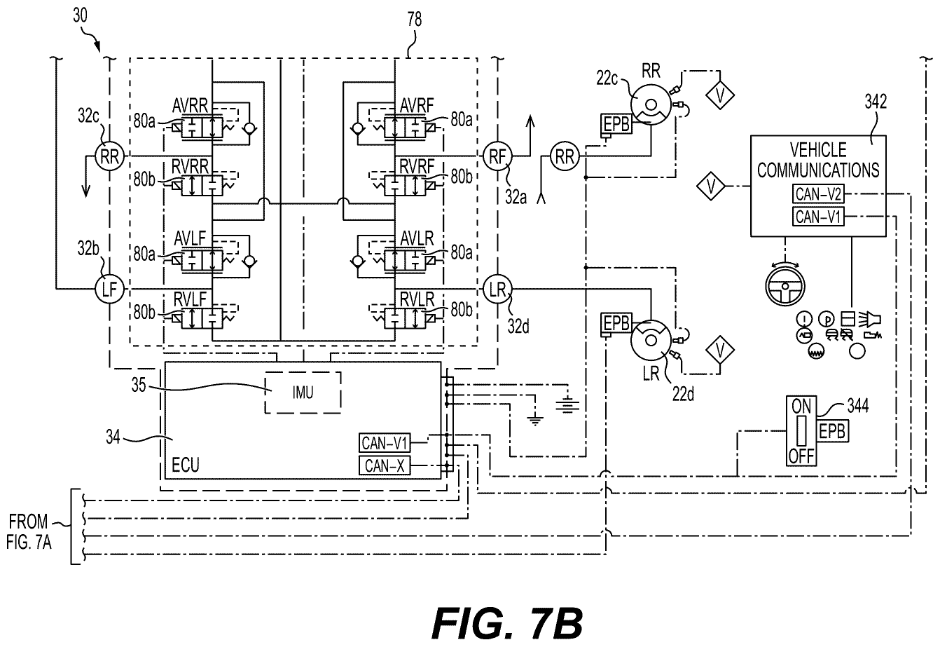

FIGS. 7A-7B show detailed schematic diagrams of two different portions of the two-box BbW system 20, including the RBU 40 and the primary brake unit 30. As shown on FIGS. 7A-7B the ECUs 34, 44 of the two-box BbW system 20 are connected to one another and are also connected to one or more external controllers 342 of a vehicle via a communications network, such as Controller Area Network (CAN bus). In some embodiments, and as shown in FIG. 7B, the first ECU 34 includes a second inertial sensor, also called an inertial measurement unit (IMU) 35 configured to sense longitudinal and lateral accelerations and/or yaw rate. In some embodiments, and as shown in FIG. 7B, the first ECU 34 may be connected to an electric parking brake (EPB) switch 344 for activating an EPB actuator EPB on one or more of the wheel brakes 22a, 22b, 22c, 22d, such as the right-rear wheel brake 22c and the left-rear wheel brake 22d. However, other ones of the wheel brakes 22a, 22b, 22c, 22d may include the EPB actuators EPB. One or more of the EPB actuators EPB may be wired to the primary brake unit 30, and one or more other ones of the EPB actuators EPB may be wired to the RBU 40. If one of the brake control units 30, 40 fails, the two-box BbW system 20 of the present disclosure can still hold the vehicle with the one or more of the EPB actuators that is connected to the other one of the brake control units 30, 40 (e.g. in case the vehicle is on a hill). One set of wheel speed sensors 140 may be wired directly to the primary brake unit 30 and the second set of wheel speed sensors 142 may be wired to a CAN bus where they can be monitored by the RBU 40 in the event of a primary brake unit 30 failure.

In some embodiments, and in some modes, such as in the fallback mode shown in FIG. 5, the second ECU 44 is configured to determine a pressure differential across either or both of the boost valves 100, 110 based on a difference between the fluid pressure in a corresponding one of the supply passages 102, 112, and the fluid pressure at the inlet port 94, as measured by the pressure sensors 120, 108, 118. This pressure difference may be called a boost ratio and can be varied by control of the second pressure supply unit 70 and the throttle valves 106, 116 based on a desired braking characteristic, in the fallback mode.

The present disclosure provides a two-box BbW system 20 for a driverless motor vehicle which receives all braking commands from intelligent systems that are part of the vehicle's hardware and software and are known here as its autopilot and a high speed private CAN connection to assure instantaneous communications between the separate brake systems. The brake system includes: a primary brake unit 30 capable of providing independent pressure control to all four wheel brakes in a standard passenger vehicle or light truck; and a redundant brake unit (RBU) 40 consisting of two isolated pump elements 71, 171 driven by a second electric motor 46 and capable of providing pressure and flow to two independent left front and right front brake circuits. The RBU includes a left front (LF) inlet port 94 and a right front (RF) inlet port 96. Each of the inlet ports 94, 96 are fluidly connected to a corresponding one of the outlet ports 92a, 92b. The RBU 40 includes two boost valves 100, 110, with one located in each independent left front and right front circuit fluidly connected to their corresponding inlet ports 94, 96 and corresponding outlet ports 92a, 92b. The two boost valves 100, 110 may each include a normally-open linear valve, such as a modulating solenoid valve. The RBU 40 includes a pressure sensor 120 located between at least one of the inlet ports 94, 96 and at least one front boost valve. The RBU 40 includes two outlet pressures sensors 108, 118 with one located in each independent left front and right front circuit fluidly connected to outlets of their corresponding pump elements 71, 171 and corresponding outlet ports 92a, 92b. The RBU 40 includes two normally-closed decrease valves 104, 114 with one located in each left front and right front circuit fluidly connected to their corresponding outlet ports 92a, 92b and inlets of their corresponding pump elements 71, 171. The RBU 40 includes two throttle valves 106, 116 with one located in each left front and right front circuit fluidly connected between their corresponding decrease valves 104, 114 and inlets of their corresponding pump elements 71, 171. The two throttle valves 106, 116 may each include normally-open linear solenoid valves. The RBU 40 includes a reservoir port 98 fluidly connected to the inlet of the two pump elements 71, 171.

The present disclosure also provides a brake system 20 for a driverless motor vehicle which receives all braking commands from intelligent systems that are part of the vehicle's hardware and software and are known here as its autopilot and a high speed private CAN connection to assure instantaneous communications between the separate brake systems. The brake system includes: a primary brake unit capable of providing independent pressure control to all four wheel brakes in a standard passenger vehicle or light truck and an RBU capable of providing independent pressure control to each front wheel brake and linked together electronically by a high speed private CAN. The primary brake unit is configured to provide independent pressure control to all four wheel brakes in a standard passenger vehicle or light truck and an RBU capable of providing independent pressure control to each front wheel brake and linked together electronically by a high speed private CAN. The brake system further includes two wheel speed sensors at each wheel brake, one on each wheel is hard wired to the primary brake unit and the other on each wheel is wired to another vehicle ECU including a CAN transceiver such that wheel speed signals are available to the corresponding ECU even with the failure of the primary brake unit or the RBU.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A redundant brake unit for a motor vehicle, comprising:
an inlet port configured to receive fluid under pressure from an external source;
an outlet port connected to a supply passage and configured for fluid connection to a wheel brake;
a reservoir port connected to a return passage and configured for fluid connection to a fluid reservoir;
a boost valve configured to selectively control fluid communication between the inlet port and the supply passage; and
a pressure supply unit including a pump element configured to pump fluid between the return passage and the supply passage, wherein the pump element has an inlet directly connected to the reservoir port with no actuated valves therebetween.

2. The redundant brake unit of claim 1, further comprising: a normally-closed valve and a throttle valve in a series configuration between the supply passage and the return passage, the throttle valve being operable to vary fluid flow therethrough to control a fluid pressure in the supply passage.

3. The redundant brake unit of claim 2, further comprising:
an outlet fluid pressure sensor configured to measure the fluid pressure in the supply passage; and
an electronic control unit configured to receive a signal from the outlet fluid pressure sensor representing the fluid pressure in the supply passage and to provide a control signal to the throttle valve for adjusting the fluid pressure in the supply passage.

4. The redundant brake unit of claim 3, further comprising an inlet fluid pressure sensor configured to measure a pressure at the inlet port and to provide a corresponding signal to the electronic control unit,
wherein the electronic control unit is configured to determine a pressure differential across the boost valve based on a difference between the fluid pressure in the supply passage and the fluid pressure at the inlet port,
wherein the electronic control unit is further configured to determine a desired output pressure setting based on the difference between the fluid pressure in the supply passage and the fluid pressure at the inlet port,
wherein the electronic control unit is further configured to generate the control signal for the throttle valve based on a difference between the desired output pressure setting and the fluid pressure in the supply passage.

5. The redundant brake unit of claim 1, further comprising:
a second inlet port configured to receive fluid under pressure from another external source;
a second outlet port connected to a second supply passage and configured for fluid connection to a second wheel brake;
a second boost valve configured to selectively control fluid communication between the second inlet port and the second supply passage; and
wherein the pressure supply unit further includes a second pump element configured to pump fluid between the return passage and the second supply passage, and the second pump element has an inlet directly connected to the reservoir port with no actuated valves therebetween.

6. The redundant brake unit of claim 5, further comprising: a second normally-closed valve and a second throttle valve in a series configuration between the second supply passage and the return passage, the second throttle valve being operable to vary fluid flow therethrough to control a fluid pressure in the second supply passage.

7. A redundant brake unit for a motor vehicle, comprising:
an inlet port configured to receive fluid under pressure from an external source;
an outlet port connected to a supply passage and configured for fluid connection to a wheel brake;
a reservoir port connected to a return passage and configured for fluid connection to a fluid reservoir;
a pressure supply unit including a pump element configured to pump fluid to the supply passage; and
a normally-closed valve and a throttle valve in a series configuration between the supply passage and the return passage, the throttle valve being operable to vary fluid flow therethrough to control a fluid pressure in the supply passage.

8. The redundant brake unit of claim 7, wherein the pump element has an inlet directly connected to the reservoir port with no actuated valves therebetween.

9. The redundant brake unit of claim 7, further comprising a boost valve configured to selectively control fluid communication between the inlet port and the supply passage.

10. The redundant brake unit of claim 7, further comprising:
an outlet fluid pressure sensor configured to measure the fluid pressure in the supply passage; and
an electronic control unit configured to receive a signal from the outlet fluid pressure sensor representing the fluid pressure in the supply passage and to provide a control signal to the throttle valve for adjusting the fluid pressure in the supply passage.

11. The redundant brake unit of claim 10, further comprising:
a boost valve configured to selectively control fluid communication between the inlet port and the supply passage; and
an inlet fluid pressure sensor configured to measure a pressure at the inlet port and to provide a corresponding signal to the electronic control unit,
wherein the electronic control unit is configured to determine a pressure differential across the boost valve based on a difference between the fluid pressure in the supply passage and the fluid pressure at the inlet port,
wherein the electronic control unit is further configured to determine a desired output pressure setting based on the difference between the fluid pressure in the supply passage and the fluid pressure at the inlet port,
wherein the electronic control unit is further configured to generate the control signal for the throttle valve based on a difference between the desired output pressure setting and the fluid pressure in the supply passage.

12. The redundant brake unit of claim 7, further comprising:
a second inlet port configured to receive fluid under pressure from another external source;
a second outlet port connected to a second supply passage and configured for fluid connection to a second wheel brake; and
a second normally-closed valve and a second throttle valve in a series configuration between the second supply passage and the return passage, the second throttle valve being operable to vary fluid flow therethrough to control a fluid pressure in the second supply passage.

13. A brake system for a motor vehicle, comprising:
a wheel brake configured to apply a braking force in response to a fluid pressure;
a primary brake unit including a first pressure supply unit (PSU) configured to generate the fluid pressure, and a fluid discharge port for providing the fluid pressure; and
a redundant brake unit including:
an inlet port fluidly coupled to the fluid discharge port of the primary brake unit,
an outlet port connected to a supply passage and to the wheel brake,
a boost valve configured to selectively control fluid communication between the inlet port and the supply passage,
a reservoir port connected to a return passage and configured for fluid connection to a fluid reservoir, and
a second PSU including a pump element configured to pump fluid between the return passage and the supply passage, wherein the pump element has an inlet directly connected to the reservoir port with no actuated valves therebetween.

14. The brake system of claim 13, wherein the redundant brake unit further comprises:
a throttle valve disposed between the supply passage and the return passage and being operable to vary fluid flow therethrough to control a fluid pressure in the supply passage;
an outlet fluid pressure sensor configured to measure the fluid pressure in the supply passage; and
an electronic control unit configured to receive a signal from the outlet fluid pressure sensor representing the fluid pressure in the supply passage and to provide a control signal to the throttle valve for adjusting the fluid pressure in the supply passage.

15. The brake system of claim 14, further comprising a normally-closed valve connected in series with the throttle valve between the supply passage and the return passage.

16. The brake system of claim 14, further comprising:
a boost valve configured to selectively control fluid communication between the inlet port and the supply passage; and
an inlet fluid pressure sensor configured to measure a pressure at the inlet port and to provide a corresponding signal to the electronic control unit,
wherein the electronic control unit is configured to determine a pressure differential across the boost valve based on a difference between the fluid pressure in the supply passage and the fluid pressure at the inlet port,
wherein the electronic control unit is further configured to determine a desired output pressure setting based on the difference between the fluid pressure in the supply passage and the fluid pressure at the inlet port,
wherein the electronic control unit is further configured to determine the control signal for the throttle valve based on a difference between the output pressure setting and the fluid pressure at the inlet port.

17. The brake system of claim 13, wherein the redundant brake unit further comprises:
a throttle valve disposed between the supply passage and the return passage and being operable to vary fluid flow therethrough to control a fluid pressure in the supply passage; and
an electronic control unit configured to receive a brake request signal from an autopilot controller and, in response to the brake request signal:
command the boost valve to a closed state;
energize the second PSU to cause the pump element to pump fluid between the return passage and the supply passage; and
provide a control signal to the throttle valve for adjusting the fluid pressure in the supply passage and to cause the wheel brake to apply the braking force.

18. The brake system of claim 13, wherein the redundant brake unit further comprises:
a second inlet port configured to receive fluid under pressure from another external source;
a second outlet port connected to a second supply passage and configured for fluid connection to a second wheel brake; and
a second normally-closed valve and a second throttle valve in a series configuration between the second supply passage and the return passage, the second throttle valve being operable to vary fluid flow therethrough to control a fluid pressure in the second supply passage.

19. The brake system of claim 13, wherein the primary brake unit further includes: a master brake cylinder coupled to a brake pedal, and a set of valves configured to selectively couple one of the master brake cylinder or the first PSU to the fluid discharge port for providing the fluid pressure to the wheel brake.

20. The brake system of claim 13, further including:
a first electronic control unit associated with the primary brake unit and configured to control operation of the first PSU;
a second electronic control unit associated with the redundant brake unit and configured to control operation of the second PSU; and
two independent wheel speed sensors each configured to measure a speed of a wheel coupled to the wheel brake, and wherein each of the first electronic control unit and the second electronic control unit is configured to monitor the speed of the wheel via a corresponding one of the two independent wheel speed sensors.

21. The brake system of claim 20, wherein the wheel brake is one of a plurality of wheel brakes,
wherein the brake system further includes two independent electronic parking brakes, each coupled to a corresponding wheel brake of the plurality of wheel brakes and configured to prevent said corresponding wheel brake from turning, and
wherein each of the first electronic control unit and the second electronic control unit is configured to control a corresponding electronic parking brake of the two independent electronic parking brakes.
